(19) United States
(12) Patent Application Publication
(10) Pub. No.: US 2014/0110929 A1
(43) Pub. Date: Apr. 24, 2014

(54) AUTHENTICATED KEEPSAKE MEMORABILIA AND KEEPSAKE HOLDER FOR RETAINING SAME

(71) Applicant: Dawn HEIDERER, Center Harbor, NH (US)

(72) Inventor: Dawn HEIDERER, Center Harbor, NH (US)

(21) Appl. No.: 14/057,508

(22) Filed: Oct. 18, 2013

Related U.S. Application Data
(60) Provisional application No. 61/716,149, filed on Oct. 19, 2012.

(51) Int. Cl. B42D 15/00

(52) U.S. Cl. CPC B42D 15/00
USPC 283/70; 283/74

(57) ABSTRACT

A method of authenticating a salvage item for use as a collector's item, the method comprising the steps of verifying the authenticity of the collected item; marking the collected item which has been verified and authenticated with desired memorabilia indicia; and placing the collected item, which was verified, authenticated and marked with desired memorabilia, on a keepsake holder.

This application claims the benefit of United States Provisional Patent Application No. 611716,149 filed on Oct. 19, 2012.

### FIELD OF THE INVENTION

The present invention relates to a method for collecting a salvage item from an important, significant and/or memorable event, verifying the authenticity of the salvaged item, authenticate the savage item and then placing the salvaged item in or on a keepsake holder, such as a lanyard, necklace, a bracelet, anklet, etc.

### BACKGROUND OF THE INVENTION

Fans of all kinds enjoy taking photographs, saving an entry ticket, collecting as item or some other keepsake such as a base ball, a tennis ball or a golf ball that was utilized during a game or match, etc., to memorialize and help such fan remember attend of a special event. It is to be appreciated that such photographs, tickets, base ball, tennis ball, golf ball, or other item or other keepsake, etc., has added value to the fan when such item or other keepsake is autographed, for example, or used during the game or match, such as a base ball, a golf ball or a tennis ball. Moreover, often times such utilized items are discarded or otherwise disposed of in some other manner.

### SUMMARY OF THE INVENTION

Wherefore, it is an object of the present invention to supply fans with a relatively inexpensive supply of keepsake memorabilia to memorialize and help fans remember attend at a special event.

Another object of the present invention is to provide a relatively inexpensive method of collecting salvaged items from a particular event, such as a race event, a sporting event, a musical event, etc., and thereafter authenticating each one of the salvaged items, by an associated governing or sponsoring authority of the event so that purchasers of the salvaged items are thereby guaranteed or insured that hey are only purchasing authentic items and not counterfeit goods.

A further object of the present invention is to provide a keepsake holder which can be easily opened, separated and/or disconnected in order to facilitate adding one or more additional keepsake memorabilia and/or removing one or more keepsake memorabilia from the keepsake holder to allow the collection of the keepsake holder to easily expand or be customized for a particular event.

Yet another object of the present invention is to a method of authenticating an item for use as a collector's item, the method comprising the steps of: collecting an item; verifying an authenticity of the item; marking the item which has been verified and authenticated with desired memorabilia indicia; and placing the item, which was verified, authenticated and marked with desired memorabilia, on a keepsake holder.

A still further object of the present invention is to method of authenticating a salvage item for use as a collector's item, the method comprising the steps of: utilizing a salvage item during an event; following use of the salvage item during the event, collecting the salvage item and verifying the authenticity of the collected salvage item; marking the collected salvage item which has been verified and authenticated with desired memorabilia indicia; and placing the collected salvage item, which was verified, authenticated and marked with desired memorabilia, on a keepsake holder.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 is a diagrammatic view showing a lanyard for use a keepsake holder and removably supporting one or more collectible or salvage items;

FIG. 2 is a diagrammatic view showing either plastic or metal end fitting attached to each opposed end of the lanyard which are suitably marked with the name of the governing authority, NASCAR in this instance;

FIG. 3 is a diagrammatic perspective view showing a lug nut as the salvage item which is supported by lanyard keepsake holder;

FIG. 4A is a diagrammatic perspective view showing a generic fender washer as a new or a salvage item which is supported by lanyard keepsake holder;

FIG. 4B is a diagrammatic perspective view showing a specific fender washer as a new or a salvage item which is supported by lanyard keepsake holder which identifies the race track and date of the race;

FIG. 5 is a diagrammatic perspective view showing a penny as the item which is supported by the lanyard keepsake holder; and

FIG. 6 is a diagrammatic perspective view showing a fender washer as the new or salvage item which is painted or colored with the color scheme of the vehicle and supported by the lanyard keepsake holder.

### DETAILED DESCRIPTION OF THE INVENTION

The present invention will be understood by reference to the following detailed description, which should be read in conjunction with the appended drawings. It is to be appreciated that the following detailed description of various embodiments is by way of example only and is not meant to limit, in any way, the scope of the present invention.

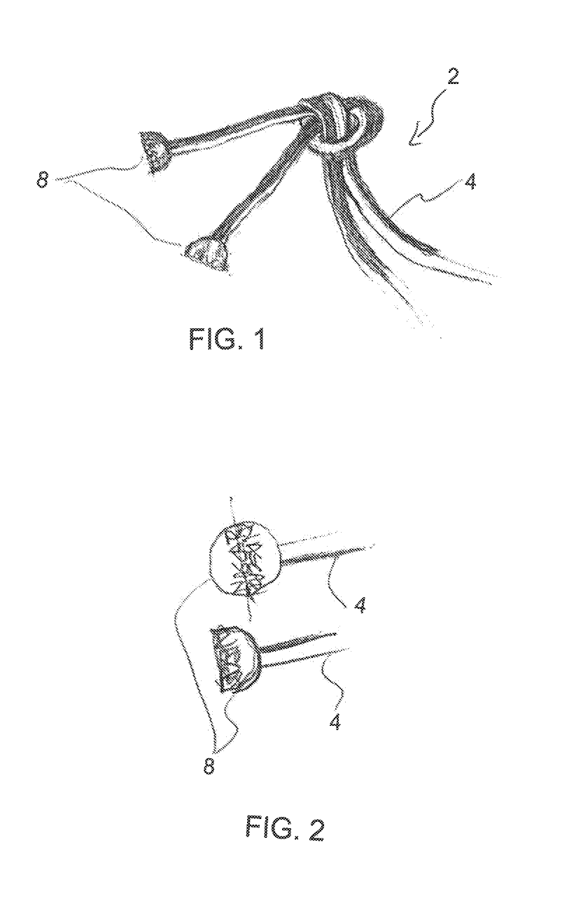

Turning now to FIG. 1, a brief description concerning the various components of the present invention will now be briefly discussed. As can be seen in this embodiment, the keepsake holder 2 generally comprises an elongate member 4, such as a lanyard, a necklace, a bracelet, an anklet, a rope, a leather strap, a leather lace, a cord, a chain, etc., or some member facilitating support of the keepsake holder 2 about the neck, the wrist, the waist, the ankle, etc., of a wearer. The keepsake holder 2 typically has a length of at least 6 inches to about 60 inches, more preferably has a length of between about 6 inches to about 36 inches or so, depending upon the particular application. Preferably the keepsake holder 2 also has a releasable mechanism or a simple knot which facilitates a secure attachment while also facilitating either adding/removing one or more additional keepsake memorabilia to or from the keepsake holder 2, as will be discussed below in further detail. As the keepsake holder 2 is conventional and well known in the art, a further detail description concerning the same is not provided. As shown in FIG. 2, opposed ends of the lanyard, for instance, may have either plastic or metal tips 8 which are suitably marked with desired indicia, the governing authority, NASCAR in this instance, or some other indicia.

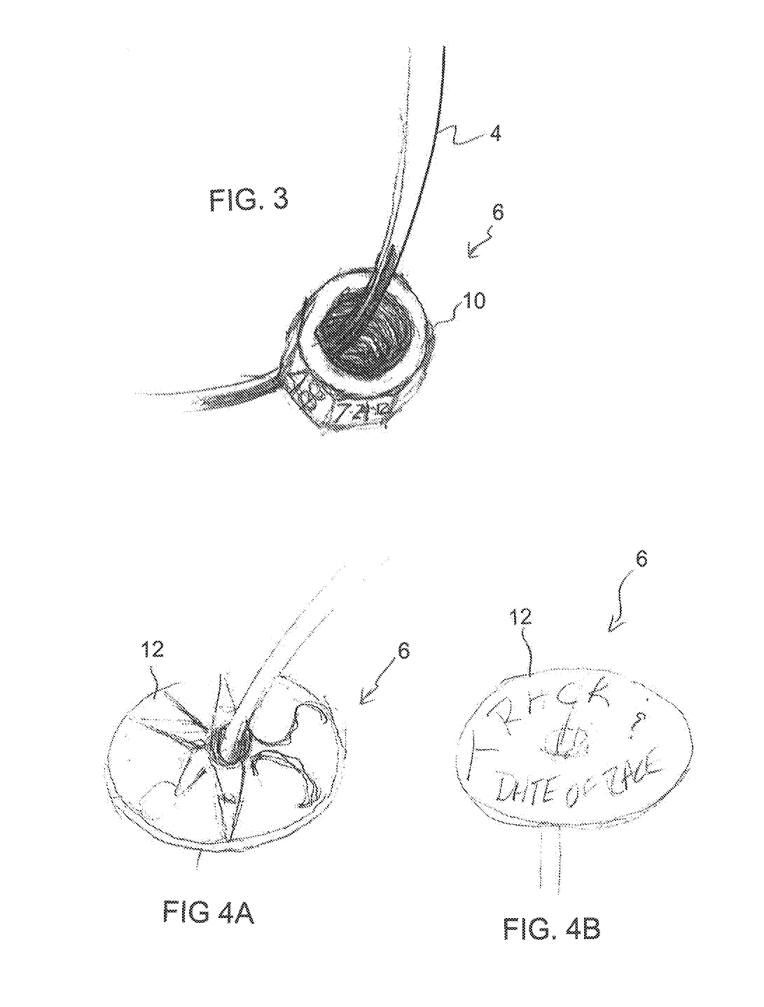

With reference now to Figs, 3-5, a further description concerning the keepsake memorabilia 6 will now be provided. As shown in FIG. 3, the keepsake memorabilia 6, in this instance, is a lug nut 10 from a NASCAR race vehicle. It is to be appreciated that during the course of each NASCAR race, or qualifying or practice round, each NASCAR vehicle will return to the pit for servicing—this typically occurs between three and five times during the course of each race, or qualifying or practice round. During such servicing, the vehicle typically undergoes refueling of the vehicle as well as replacement of the tires. When each of the four wheels, supporting a respective tire/rim of the vehicle, are replaced, and each one of the lug nuts 10, e.g., typically five lug nuts 10, that were previously utilized in retaining the wheels to the vehicle is removed, a new set of five lug nuts 10 is utilized to affix each new wheel, containing a new, fresh tire, to the vehicle. Thereafter, each one of the utilized and removed lug nuts 10 are either discarded or possibly recycled but form a potential source for a salvage item which has value to race fans.

It is be appreciated that a number of avid NASCAR fans desire to obtain various keepsake memorabilia 6 from a particular race as a keepsake, e.g., to remind such race fan of a specific victory by his/her favorite driver, a particular race attended by such race fan, a memorable event that occurred at a particular race track, etc. Moreover, the value of the keepsake memorabilia 6 is increased greatly to the fan in the event that the keepsake memorabilia 6 was utilized during the race, or qualifying or practice round, and is authenticated by the appropriate authorities. In this instance, the NASCAR authorities verify and authenticate that the specific lug nut 10 was, in fact, utilized during the course of the race, or qualifying or practice round, and removed from a specific vehicle, e.g., car number 48. Further, typically the value of the keepsake memorabilia 6 to the fan is further increase if the specific race course or location, e.g., Dayton 500, Brickyard 400, New Hampshire Motor Speedway, at which the specific lug nut 10 was used during the course of the race, or qualifying or practice round, is also identified on the keepsake memorabilia 6. Still further, the value of the keepsake memorabilia 6 to the fan is further increase if the specific date of the race, e.g., Jul. 2, 2012, is also identified on the keepsake memorabilia 6.

To facilitate collection of lug nuts 10, during the course of a race, or qualifying or practice round, the pit crew of each race car driver will collect and store each one of the removed lug nuts 10 in a designated storage bin or container, for example. At the end of each race, the pit crew, of each race car, will then transfer the collection of removed lug nuts 10 to the governing authority, e.g., NASCAR in this instance, for appropriate identification and authentication. The governing authority will then place desired memorabilia indicia, e.g., identify the race car on which the lug nut 10 was utilized, the race name or location of the race, the date of the race, the time that the lug nut 10 was either installed or removed from the vehicle, etc. The placement of the desired memorabilia indicia can by way of laser etching, engraving, panting, etc.

It is to be appreciated that the amount of information that can be included on the keepsake memorabilia 6, can vary from event to event, as well as depending upon the type or kind of the keepsake memorabilia 6 that is collected. The important aspect is that the keepsake memorabilia 6 be appropriately authenticated, in some manner, by the governing authority so that the fan or consumer is thereby guaranteed and ensured that he/she is only purchasing an authenticated item and not a counterfeit item.

With reference now to FIGS. 4A, 4B and 6, the keepsake memorabilia 6, in this instance, is a fender washer 12 which is commonly used to assist with securing the fenders and/or other components to the vehicle. It is to be appreciated that the fenders are replaced less frequently than the tires/wheels of the vehicle and thus a sufficient supply of fender washers, which were actually utilized during the course of a race, or possibly a qualifying or practice round, and authenticated by the governing authority, will be substantially less than the supply of lug nuts 10, for example, and thus potentially more valuable if utilized during a race, e.g., a specific crash for example. Notwithstanding this, unused original equipment fender washers 12 are still suitable for use as the keepsake memorabilia 6 and an ample supply can be obtained from the same original equipment and/or authorized supplier which normally supplies NASCAR race vehicle with fender washers 12 which are utilized for securing the fenders to the race vehicles. Such fender washers 12 are also authenticated by governing authority, e.g., NASCAR, and suitably marked with memorabilia indicia indicating, for example, the location of the race, the name of the race, the race vehicle number, the date of the race, etc. (see FIG. 4B). It is be appreciated that other memorabilia indicia can also be marked on the fender washer 12, e.g., the name of a particular driver, the car number of a particular vehicle, the painting colors or scheme of a particular vehicle, the sponsors of a particular vehicle, etc. (see FIG. 4A). It is to be appreciated that a first side of the fender washer 12 may be marked with one set of desired memorabilia indicia while the second opposite side of the fender washer 12 may be marked with another set of desired memorabilia indicia. Alternatively, both sides of the fender washer 12 may be marked with the same set of desired memorabilia indicia.

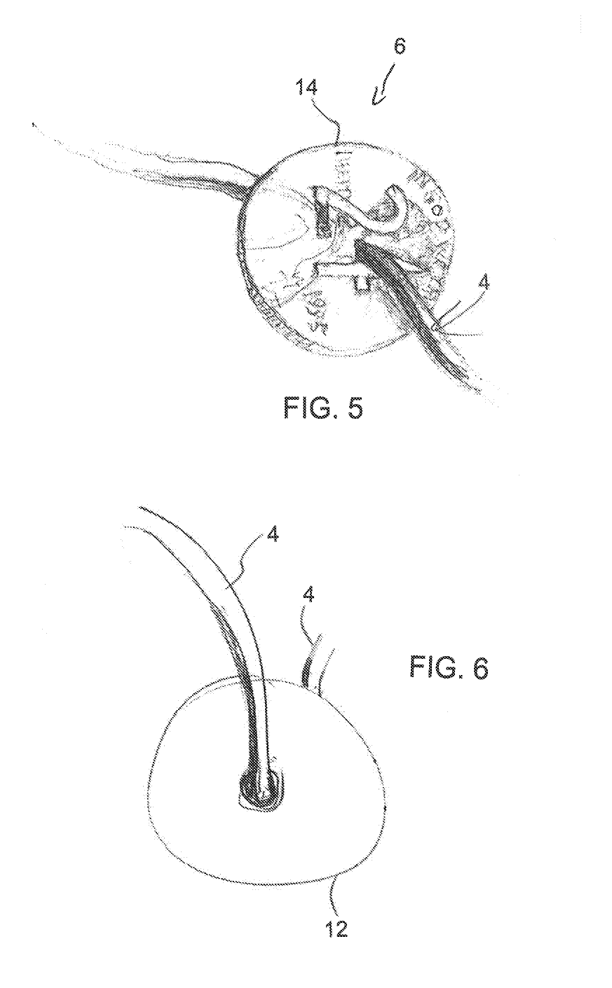

With reference now to FIG. 5, the keepsake memorabilia 6, in this instance, is a penny 14 or some other coin (for purposes of luck). It is to be appreciated that pennies, or other conventional coins, are suitable for use as the keepsake memorabilia 6 once such coins are authenticated by governing authority, e.g., NASCAR, and suitably marked with memorabilia indicia indicating, for example, the venue of the race, the name of the race, the race vehicle number, the date of the race, the name of a particular driver, the car number of a particular vehicle, the painting colors or scheme of a particular vehicle, the sponsors of a particular vehicle, etc.

As noted above, the keepsake holder 2 has a releasable mechanism or a simple knot which facilitates either adding/removing one or more additional keepsake memorabilia 6 to or from the keepsake holder 2 to either expand or customize the collection for a particular event. Accordingly, as NASCAR fans attend different race events, such NASCAR fans can collect one or more additional keepsake memorabilia 6 and add the same to the keepsake holder 2 or customize the keepsake holder 2 for a particular event or race.

It is to be appreciated that a variety of different techniques and methods can be utilized with respect to marketing the keepsake memorabilia 6. For example, the keepsake memorabilia 6 may be simply marked by painting or enameling a specific color scheme or number or placing a decal indicating the number or color scheme on the keepsake memorabilia 6. Alternatively, the keepsake memorabilia 6 may be engraved, laser etched or otherwise permanently marked with the desired memorabilia indicia, e.g., the number of the race vehicle from which the lug nut 10 was removed, the date the lug nut 10 was utilized, the location of the race event, etc.

It is to be appreciated that the keepsake holder 2 may take a variety of different shapes or forms. For example, each one of the keepsake memorabilia 6 may be contained within its own individual (plastic) container which may be either permanently sealed, so as to facilitate viewing thereof, or may be releasably sealable within a container which facilitates periodic viewing and access thereto. Alternatively, the keepsake memorabilia 6 may be loosely contained within a divided wooden case or some other display case or structure which facilitates display, viewing and/or access thereto as desired by the end user.

While various embodiments of the present invention are above described in detail, it is apparent that various modifications and alterations of those embodiments will occur to and be readily apparent those skilled in the art. However, it is to be expressly understood that such modifications and alterations are still within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Wherefore, I/we claim:

1. A method of authenticating an item for use as a collector's item, the method comprising the steps of:
collecting an item;
verifying an authenticity of the item;
marking the item which has been verified and authenticated with desired memorabilia indicia; and
placing the item, which was verified, authenticated and marked with desired memorabilia, on a keepsake holder.

2. A method of authenticating a salvage item for use as a collector's item, the method comprising the steps of:
utilizing a salvage item during an event;
following use of the salvage item during the event, collecting the salvage item and verifying an authenticity of the collected salvage item;
marking the collected salvage item which has been verified and authenticated with desired memorabilia indicia; and
placing the collected salvage item, which was verified, authenticated and marked with desired memorabilia, on a keepsake holder.

3. The method of authenticating the salvage item for use as the collector's item according to claim 2, further comprising the step of using a lug nut from a race vehicle as the salvage item.

4. The method of authenticating the salvage item for use as the collector's item according to claim 3, further comprising the step of marking the lug nut with at least a number of a race vehicle on which the lug nut was utilized during a race.

5. The method of authenticating the salvage item for use as the collector's item according to claim 3, further comprising the step of marking the lug nut with both a number of a race vehicle on which the lug nut was utilized during a race and a date of the race.

6. The method of authenticating the salvage item for use as the collector's item according to claim 3, wherein further comprising the step of marking the lug nut with both a number of a race vehicle on which the lug nut was utilized during a race and a location of the race.

7. The method of authenticating the salvage item for use as the collector's item according to claim 3, wherein further comprising the step of marking the lug nut with a number of a race vehicle on which the lug nut was utilized during a race, a date of the race and a location of the race.

8. The method of authenticating the salvage item for use as the collector's item according to claim 2, further comprising the step of using one of a fender wash salvaged from a race vehicle as the salvage item or an unused, NASCAR authorized fender washer as the salvage item.

9. The method of authenticating the salvage item for use as the collector's item according to claim 2, further comprising the step of using a fender wash as the salvage item.

10. The method of authenticating the salvage item for use as the collector's item according to claim 9, further comprising the step of marking a first side of the fender washer with a first set of desired memorabilia indicia and marking a second opposite side of the fender washer with another set of desired memorabilia indicia.

11. The method of authenticating the salvage item for use as the collector's item according to claim 9, further comprising the step of marking both a first and a second side of the fender washer with a same set of desired memorabilia indicia.

12. The method of authenticating the salvage item for use as the collector's item according to claim 9, further comprising the step of marking the fender washer with at least a number of a race vehicle.

13. The method of authenticating the salvage item for use as the collector's item according to claim 9, further comprising the step of marking the fender washer with at least a number of a race vehicle and a date of the race.

14. The method of authenticating the salvage item for use as the collector's item according to claim 9, further comprising the step of marking the fender washer with at least one of a location of a race, a name of a race, a race vehicle number, a date of a race, a name of a particular driver, a car number of a particular vehicle, a paint color or scheme of a particular vehicle and a sponsors of a particular vehicle.

15. The method of authenticating the salvage item for use as the collector's item according to claim 2, further comprising the step of using a penny as the salvage item.

16. The method of authenticating the salvage item for use as the collector's item according to claim 15, further comprising the step of marking the penny with at least one of a location of a race, a name of a race, a race vehicle number, a date of a race, a name of a particular driver, a car number of a particular vehicle, a paint color or scheme of a particular vehicle and a sponsors of a particular vehicle.

17. The method of authenticating the salvage item for use as the collector's item according to claim 2, further comprising the step of using one of a lanyard, a necklace, a bracelet, an anklet, a rope, a leather strap and a chain as the keepsake holder.

18. A salvage item which comprises a collector's item, the salvage item being utilized during an event;
following use of the salvage item during the event, the salvage item being collected and verified for authenticity;
thereafter the collected salvage item, which has been verified and authenticated, being marked with desired memorabilia indicia; and
the collected salvage item, which was verified, authenticated and marked with desired memorabilia, being placed on a keepsake holder.

19. The salvage item which comprises the collector's item according to claim 2, wherein the salvage item comprises one of a lug nut from a race vehicle, a fender washer and a coin.

20. The salvage item which comprises the collector's item according to claim 2, wherein the keepsake holder comprises one of a lanyard, a necklace, a bracelet, an anklet, a rope, a leather strap, a leather lace, a cord and a chain.
